(19) United States
(12) Patent Application Publication
(10) Pub. No.: US 2010/0110298 A1
(43) Pub. Date: May 6, 2010

(54) VIDEO TRANSMISSION CONSIDERING A REGION OF INTEREST IN THE IMAGE DATA

(75) Inventor: Michael James Knee, Hants (GB)

Correspondence Address: MICHAEL BEST & FRIEDRICH LLP, 100 E WISCONSIN AVENUE, Suite 3300, MILWAUKEE, WI, 53202, US

(73) Assignee: SNELL LIMITED, Reading, Berkshire (GB)

(21) Appl. No.: 12/529,950

(22) PCT Filed: Mar. 5, 2008
(86) PCT No.: PCT/GB08/50158

§ 371 Date: Oct. 9, 2009

(30) Foreign Application Priority Data
Mar. 5, 2007 (GB) 0704226.0

(51) Int. Cl. H04N 9/74; H04N 7/12

(52) U.S. Cl. 348/581; 375/240.29; 375/240.25; 375/E07.076; 375/E07.027; 348/E09.055

(57) ABSTRACT

To enable efficient use of limited bandwidth in transmitting video, a region of interest is determined in each image. Before coding, the image is spatially scaled, with magnification applied inside that a region of interest. The scaled images are then compression encoded. Meta-data identifying the location of the region of interest accompanies the transmitted video so that, after decoding, the scaling can be reversed.

### FIELD OF INVENTION

This invention concerns processing video material for relatively low-bandwidth transmission typically to small-screen displays.

### BACKGROUND OF THE INVENTION

There is considerable interest in the transmission of video material to small, hand-held displays. Video material produced for television and the cinema is often unsuitable for such transmission because of the low available data-rate and the inherently low resolution of small displays.

One solution to this problem is to select that portion of the picture area which contains the most important action, and to transmit only this “region of interest” to the small display. However, this choice of region of interest is imposed on the viewer, who then no longer has the option of looking at other parts of the picture. There is therefore a need for a method of transmission which allows the viewer to choose whether or not to limit his view to a region of interest whilst making best use of the limited resolution of the system.

### SUMMARY OF THE INVENTION

The invention consists in one aspect in a method and apparatus for video transmission in which one or more images in a video sequence are spatially scaled prior to an encoding process such that magnification is applied in a region of interest within an image and reduction is applied outside that region of interest. The spatial scaling factor may decrease monotonically from a maximum value at a point in the region of interest to a minimum value outside the region of in interest. The location of the said region of interest can change during the sequence.

Advantageously the location of the said region of interest is transmitted as meta-data which accompanies the transmitted video. The size and shape of the region of interest or the function by which spatial factor varies across the image may also be transmitted as meta-data. Sending only coordinates identifying the centre of interest will offer important advantages and will minimise the bandwidth allocated to meta-data. Varying not only the location of the region of interest but its size or shape (or the functions by which the spatial scaling factors vary in two dimensions) may offer still further advantages.

Suitably the said spatial scaling prior to an encoding process is reversed following a decoding process.

In preferred embodiments the images of the said video sequence are comprised of pixels and the said scaling processes do not change the number of pixels comprising an image.

Spatial-frequency enhancement may be applied to parts of an image which have been reduced.

Advantageously the strength of the said spatial-frequency enhancement varies in dependence on the said spatial scaling factor.

Transmission (as that term is used in this specification) may of course take a wide variety of forms including various techniques associated with internet access, wireless delivery and mobile telephony as well as more specific television transmission techniques.

### BRIEF DESCRIPTION OF THE DRAWINGS

An example of the invention will now be described with reference to the drawings in which:

FIGS. 1a and 1b show graphs of spatial mapping functions.

FIG. 2 shows a block diagram of a video pre-encoding process according to an embodiment of the invention.

FIG. 3 shows a video post-encoding process according to an embodiment of the invention.

### DETAILED DESCRIPTION OF THE INVENTION

In the invention, an image (forming part of a video sequence) to be transmitted is scaled, prior to transmission, according to a spatial mapping function, which enlarges a region of interest within the image that contains the most important information. Typically the overall size of the image (i.e. the number of pixels) is not changed, so that parts of the image which are far from the region of interest are reduced in size so as to allow more of the available pixels to be used to represent the region of interest.

In the subsequent transmission process the image will be spatially down-sampled (possibly as part of a data compression process) so as to facilitate reduced-bandwidth transmission to a small display. The enlargement of the region of interest will avoid, or reduce, the loss of resolution that would otherwise result from this down-sampling. The spatial mapping function corresponds to a smoothly-varying scaling factor, such that a maximum magnification is applied at the centre of the region of interest, and a minimum magnification (which will be less than unity) is applied to parts of the image which are furthest from the centre of the region of interest; intermediate magnification factors are applied elsewhere. The scaling factor thus reduces monotonically from its value at the centre of the region of interest.

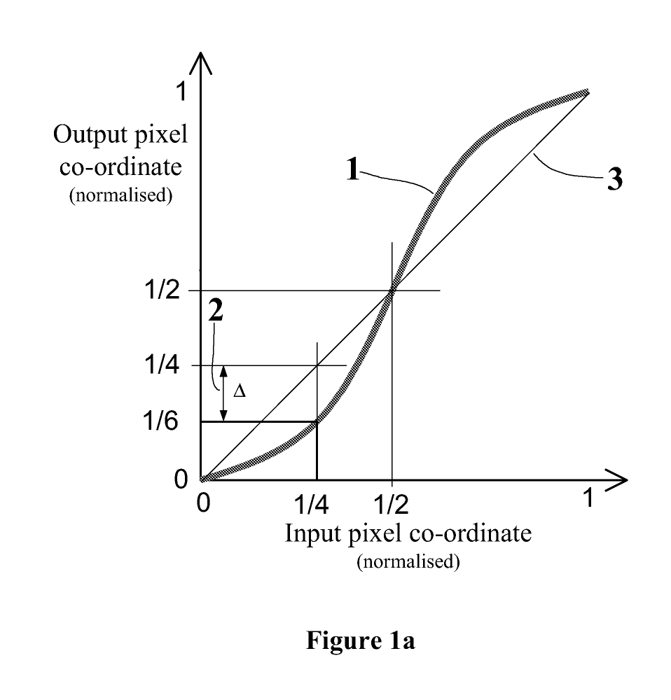

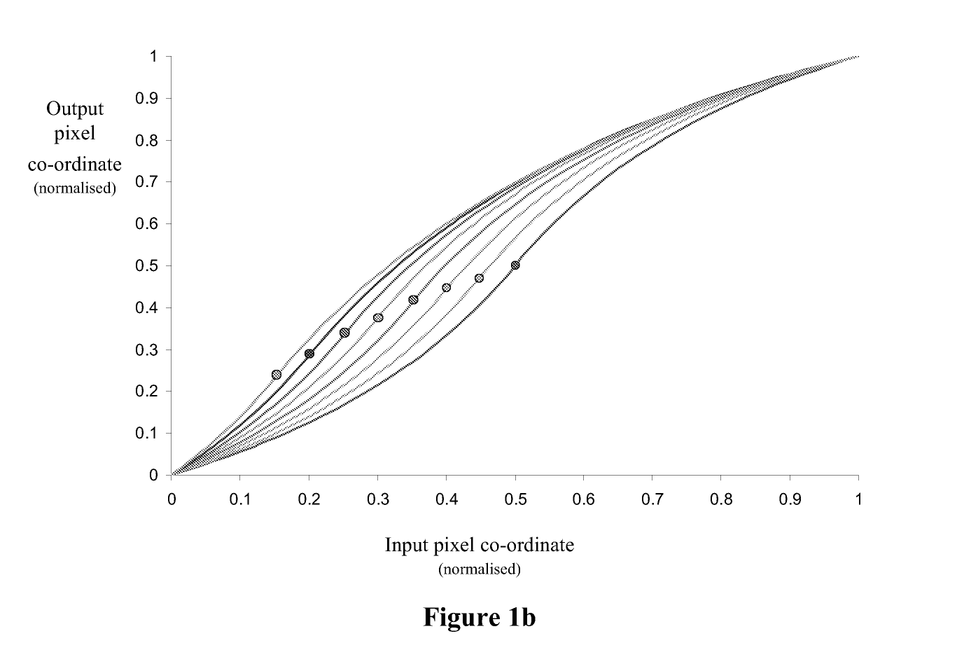

FIG. 1a shows an example of a suitable smoothly-varying mapping function. The figure is a graph of output pixel position versus input pixel position, and the function is shown by the curve (1). The axes of the graph are normalised values of a pixel co-ordinate; i.e. zero represents one edge of the image, unity represents the opposite edge of the image and one half represents the centre of the image. In FIG. 1 it is assumed that the centre of the region of interest corresponds to the centre of the image.

The equation for the curve (1) is:

y=x÷2(1−x) for values of x≦½; and

y=(3x−1)÷2x for values of x≧½

When pixel positions are mapped according to this function the magnification at a particular point in the image is equal to the gradient y′ (first derivative) of the function. This is given by:

y′=1÷2(1−x)² for values of x≦½
and the function is symmetrical about the point x=½

The magnification (in the direction of the relevant co-ordinate axis) is therefore one half at the picture edges, and two in the centre (i.e. the assumed centre of the area of interest).

If the centre of the region of interest does not have the co-ordinate value one half, a different mapping function is required. FIG. 1b shows a family of suitable mapping functions for region of interest centre co-ordinates in the range 0.15 to 0.5. For each illustrated function the point on the curve corresponding to the centre of the region of interest is indicated by a small circular marker. The slope of each curve (i.e. the magnification value) is always two at the centre of the region of interest, but the magnification at the edges depends on the position of the centre of the region of interest; and, opposite edges have unequal magnification values if the region of interest in not centrally located.

If we denote the difference between the region of interest centre co-ordinate and one half by the parameter S (having a positive value, and assuming that the region of interest is moved towards the origin of the co-ordinate system), then the equation defining the family of curves illustrated in FIG. 1b is:

y=x÷2(1−S)(1−S−x)
for values of x≦½; and

y={(1−2S)÷(2−2S)}+{2(x−½+S)÷[1+b(x−½+S)]}
for values of x≧½
Where b is a constant such that:

b=(2+4S−8S²)÷(1+2S)

The above equations only apply to the case where the centre of the region of interest is nearer to the co-ordinate origin than the centre of the image. The mapping for the case where the region of interest centre is further away from the origin can be obtained by simply reversing the scales of the co-ordinate axes in FIG. 1a, so that the points (0,0) and (1,1) are interchanged.

So far, mapping in only one direction has been described. Typically, analogous mapping would be applied in the horizontal and vertical directions. This means that for non-square images the magnification will not be isotropic. If this were considered undesirable it would be possible to derive alternative mapping to achieve isotropic magnification.

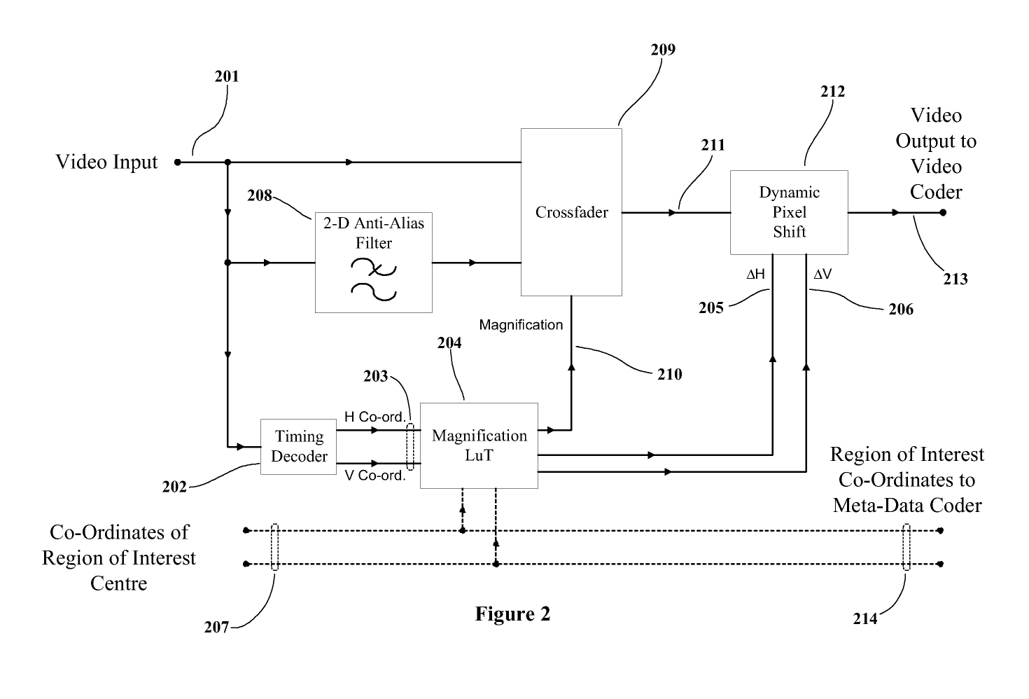

FIG. 2 shows an example of a video pre-processor which modifies an image prior to transmission. The figure assumes that the image is represented as a progressively-scanned, raster-ordered stream of pixel data values accompanied by timing reference information; the skilled person will appreciate that other formats can be used and other implementations of the described processes are possible (particularly if the image, or a sequence of images, is represented by one or more data files in a computer).

Referring to FIG. 2 an input video signal (201), is applied to a timing decoder (202) which uses the timing reference information to derive the horizontal and vertical Cartesian co-ordinates (203) of each pixel. These co-ordinates are passed to a magnification look-up-table (204), which derives respective horizontal and vertical pixel shift values, ΔH (205) and ΔV (206), for each pixel. These pixel shift values (which can be positive or negative) correspond to the distance each pixel should be moved in order to apply the relevant pixel-mapping.

For example, in FIG. 1, pixels having the co-ordinate ¼ are to be shifted to co-ordinate position ⅙. The required shift, which is in the negative direction, is the difference between these co-ordinate values and is shown in FIG. 1 by the distance Δ (2) between the mapping function (1) and the line y=x (3).

Returning to FIG. 2, the magnification look-up-table (204) also receives the co-ordinates (207) of the region of interest. These co-ordinates can be determined by an operator, or by an automatic method, for example the method of determining the centroid of the foreground segment described in WO2007/093780. These co-ordinates enable the look-up-table (204) to apply a smoothly-varying mapping function, having maximum magnification at the centre of the region of interest, by determining appropriate values for ΔH (205) and ΔV (206).

Those parts of the image which are remote from the centre of the region of interest will be reduced in size (i.e. the pixel mapping process will effectively shift input pixels closer together) and this will lead to aliassing of high spatial-frequencies. In order to avoid this, the input video (201) is also fed to a two-dimensional anti-alias low-pass filter (208). This filter has a cut-off frequency chosen to reduce aliassing to an acceptable level in the areas of lowest magnification. For example, the mapping function shown in FIG. 1 has a minimum magnification of one half, and so a suitable filter would cut off at one quarter of the vertical and horizontal sampling frequencies of the input raster; i.e. at half the respective vertical and horizontal Nyquist frequencies.

The output from the anti-alias filter (208) is combined with the unfiltered input (201) in a cross-fader (209). This is controlled by a magnification signal (210) from the look-up-table (204), which indicates the magnitude of the magnification to be applied to the current pixel. This value is combination of the horizontal and vertical magnification factors, such as the square root of the sum of the squares of these factors.

When the magnification signal (210) indicates that the current pixel is to be enlarged, the cross-fader (209) routes the unfiltered video input (201) to its output (211). When the magnification signal (210) indicates that the minimum magnification is to be applied, the cross-fader (209) routes the output from the anti-alias filter (208) to its output (211). For other magnification values less than unity the cross-fader outputs a blend of filtered and unfiltered signals with proportions linearly dependant on the magnification value (210).

The video (211) from the cross-fader (209) is processed in a pixel shifter (212) which applies the respective horizontal and vertical pixel shift values ΔH (205) and ΔV (206). This can use cascaded horizontal and vertical shift processes. Integral pixel-shift values can be achieved by applying an appropriate delay to the stream of pixel values. Any non-integral part of the required shift can be obtained by simple bi-linear interpolation of the values of the pixels preceding and succeeding the required position.

The video (213) resulting from the pixel shift process represents an image which has been magnified at the centre of the region of interest and reduced at positions remote from the centre of the region of interest. This is input to a subsequent transmission system, for example a compression coder and COFDM

RF transmitter. As the number of pixels representing the area of interest has been increased, and the number of pixels representing other areas has been reduced the transmitted quality of the area of interest will be improved.

If the transmitted signal is decoded and displayed conventionally, it will, of course, be geometrically distorted. Preferably the geometric distortion introduced by the system of FIG. 2 is reversed before the image or images are displayed. In order to make this possible the position of the region of interest must be transmitted along with the video signal (213). This can be done by transmitting the co-ordinates of the region of interest as meta-data which accompanies the video. The output (214) from the system of FIG. 2 represents this data.

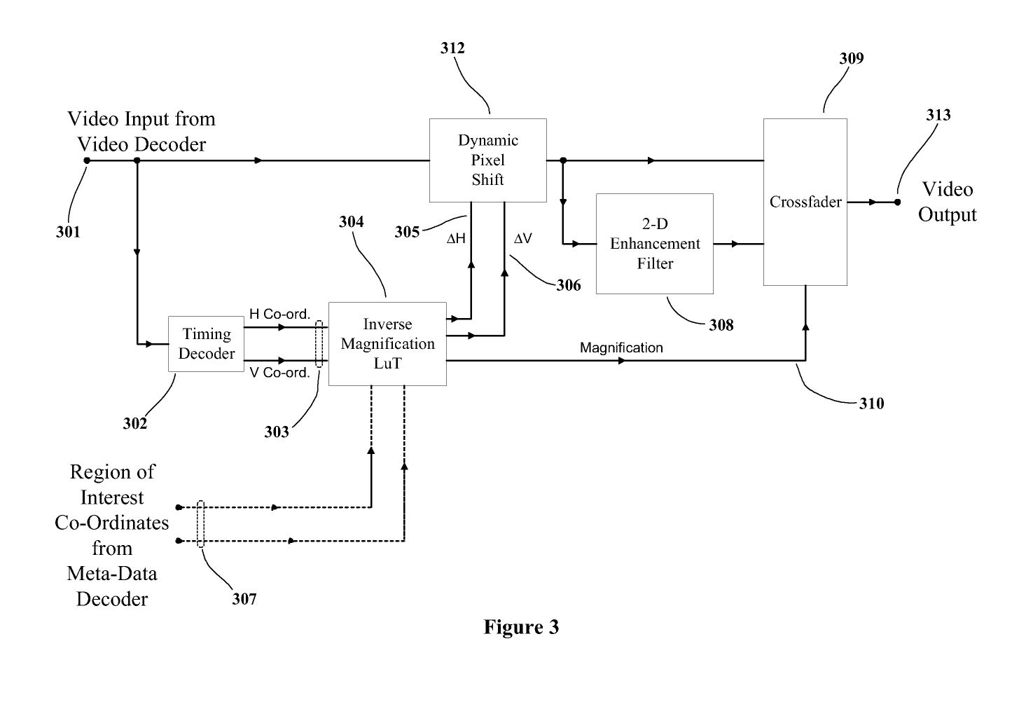

An example of a method of reversing the geometric distortion prior to display is shown in FIG. 3. Referring to this Figure, a received video signal (301) (for example the output (213) of FIG. 2 after passing through a compressed transmission channel) is input to a timing decoder (302), which recovers the horizontal and vertical co-ordinates (303) of the current pixel. These co-ordinates are input to an inverse magnification look-up table (304), which also receives the co-ordinates of the region of interest (307) from metadata carried in association with the video (301).

The inverse magnification look-up-table (304) derives the necessary horizontal and vertical pixel shifts, ΔH (305) and ΔV (306), to be applied to the video (301) by a pixel shifter (312) so as to reverse the shifts carried out by the pixel shifter (212) of FIG. 2.

The output from the pixel shifter (312) is input to a cross-fader (309) and a two-dimensional spatial-frequency enhancement filter (308). The purpose of the enhancement filter is to provide some subjective compensation for the lost spatial resolution in areas remote from the centre of the region of interest. A suitable (one-dimensional) filter is given by the equation:

F(P)=−¼P₋₁+1½P₀−¼P₁
Where: P₋₁ is the value of the previous pixel
P₀ is the value of the current pixel
P₁ is the value of the succeeding pixel

The required two-dimensional filter can be obtained by applying the above filter twice in cascade, once vertically and once horizontally.

A magnification signal (310) from the inverse magnification look-up-table (304) controls the crossfader (309) in an analogous way to the cross-fader (209) in FIG. 2. When the current pixel is in an area which has been magnified, the cross-fader (309) selects the unfiltered output of the pixel shifter (312); when the current pixel is in an area subject to maximum reduction, the output of the filter (308) is selected; and, where intermediate reduction values have been applied, a blend of filtered and unfiltered signals is formed in proportion to the degree of reduction.

The output (313) from the cross-fader (309) is suitable for display. A portion of the image can be enlarged (in a separate process, possibly controlled by the viewer) and if this portion corresponds to the region of interest improved resolution will be provided. If some other portion is selected, less resolution will have been transmitted, but some subjective compensation for this loss will be provided by the action of the enhancement filter (308). To the extent that the portion of the image into which the viewer wishes to zoom has been correctly identified as the region of interest, a substantial advantage has been achieved. That portion may be displayed at a resolution which could not have been achieved (without the invention) in transmitting the image over the limited bandwidth. The optional technique—discussed earlier—of allowing the size of the region of interest (or the function by which the spatial scaling factor varies over the image) to vary from image to image or from sequence to sequence may be used here to take into consideration the confidence with which a prediction can be made of the viewer's choice of region to zoom into.

Alternative implementations of the invention are possible. Other smoothly-varying pixel mapping functions could be used and the magnification could be held at a constant value (in either one or two dimensions) at some fixed distance from the centre of the region of interest.

The spatial-frequency enhancement process (the filter (308) and the cross-fader (309)) could be included in the pre-processor (FIG. 2) rather than being applied after reversal of the spatial mapping.

Two-dimensional processes could replace cascaded horizontal and vertical processes. Larger-aperture filters could be used for anti-aliassing, pixel shifting and enhancement. The process could be performed in other than real time. The processing can be performed with dedicated hardware, with software running on programmable data or video processing apparatus or with a combination of dedicated and programmable apparatus.

1. A method of video transmission comprising the steps of receiving a video sequence of images; determining a region of interest for at least some of the images, the location of the region of interest varying between at least two images in the sequence; spatially scaling at least some of the images using a spatial scaling factor such that magnification is applied in a region of interest within an image and reduction is applied outside that region of interest, the spatial scaling factor decreasing monotonically from a maximum value at a point in the region of interest to a minimum value outside the region of in interest; compression encoding the video sequence including said spatially scaled images; transmitting the compression encoding sequence; compression decoding the transmitted video sequence; and, preferably, reversing the spatial scaling for display of the video.

2. A method according to claim 1 in which the location of the said region of interest is transmitted as meta-data which accompanies the transmitted video.

3. A method according to claim 1, in which spatial-frequency enhancement is applied to parts of an image which have been reduced, the strength of the said spatial-frequency enhancement preferably varying in dependence on the said spatial scaling factor.

4. A method of video processing for transmission in which one or more images in a video sequence are spatially scaled prior to an encoding process such that magnification is applied in a region of interest within an image and reduction is applied outside that region of interest and the spatial scaling factor decreases monotonically from a maximum value at a point in the region of interest to a minimum value outside the region of in interest, wherein the location of the said region of interest changes during the sequence.

5. A method according to claim 4 in which the location of the said region of interest is transmitted as meta-data which accompanies the transmitted video.

6. A method according to claim 4 in which the images of the video sequence are comprised of pixels and the said scaling process does not change the number of pixels comprising an image.

7. Apparatus for processing a video sequence prior to an encoding process, comprising a video input for receiving a video sequence of images; a region of interest unit for determining or receiving the location in an image of a region of interest, which region of interest is allowed to vary from one image to another; a spatial scalar unit in which images are spatially scaled such that magnification is applied in the region of interest and reduction is applied outside that region of interest with a spatial scaling factor decreasing monotonically from a maximum value at a point in the region of interest to a minimum value outside the region of interest; and a video output for providing the video sequence including the scaled images to an encoder for compression encoding and subsequent transmission.

8. Apparatus according to claim 7, further comprising a meta-data output enabling the location of the region of interest to be transmitted as meta-data which accompanies the transmitted video.

9. Apparatus according to claim 7, in which the images of the said video sequence are comprised of pixels and the said scaling process does not change the number of pixels comprising an image.

10. Apparatus according to claim 7, further comprising an anti-alias filter, the strength which is controlled by the spatial scaling factor.

11. A method of processing a video sequence following a decoding process so as to reverse variable spatial scaling applied in a prior encoding process, wherein the location in the image where maximum reduction is to be applied following the said decoding process is defined by metadata which accompanies the said video sequence, and the scaling factor increases monotonically with distance from the said location in the image to a maximum value at another location within the image.

12. A method according to claim 11 in which the images of the video sequence are comprised of pixels and the said process so as to reverse variable spatial scaling does not change the number of pixels comprising an image.

13. A method according to claim 11 in which spatial-frequency enhancement is applied to parts of an image which have been enlarged following the said decoding process, in which the strength of the said spatial-frequency enhancement preferably varies in dependence on the said enlargement.

14. Apparatus for processing a video sequence following a decoding process so as to reverse variable spatial scaling applied in a prior encoding process, comprising a video input for receiving a video sequence of images from a compression decoder; a meta-data input for receiving the location in an image of a region of interest where maximum reduction is to be applied, which region of interest is allowed to vary from one image to another; and a spatial scalar unit in which images are spatially scaled such that a reduction is applied in the region of interest and a magnification is applied outside that region of interest and a video output for providing the video sequence for display.

15. Apparatus according to claim 14, comprising a spatial enhancement filter, the strength of which is controlled by the spatial scaling factor.
